(19) United States
(12) Patent Application Publication
(10) Pub. No.: US 2026/0307152 A1
(43) Pub. Date: Oct. 8, 2026

(54) PASTE DEPOSITION SYSTEM

(71) Applicant: Tritone Technologies Ltd., Rosh HaAyin (IL)

(72) Inventors: Eli KEDAR, Beit-Dagan (IL); Rami BEN-MAIMON, Yehud (IL); Alon FELDMAN, Kibbutz Kfar-Menachem (IL); Ofer BEN-ZUR, Hod-HaSharon (IL)

(73) Assignee: Tritone Technologies Ltd., Rosh HaAyin (IL)

(21) Appl. No.: 19/484,926

(22) PCT Filed: May 15, 2024
(86) PCT No.: PCT/IL2024/050467

§ 371 Date: Nov. 17, 2025

Related U.S. Application Data
(60) Provisional application No. 63/466,727, filed on May 16, 2023.

(51) Int. Cl. B22F 12/58; B22F 12/67; B22F 12/90; B28B 1/00; B33Y 30/00; B33Y 50/00

(52) U.S. Cl. CPC B22F 12/58; B22F 12/67; B22F 12/90; B28B 1/001; B33Y 30/00; B33Y 50/00

(57) ABSTRACT

A paste dispenser for dispensing paste to discontinuously fill a mold to form successive layers in an additive manufacturing process, comprises an applicator mounted in the paste dispenser to dispense the paste into the mold one layer at a time. The applicator comprises two blades and a volume in between, which blades are tilted so that the ends towards the mold face away from a paste dispensing direction of travel. The rear blade dispenses paste and the front blade acts as a barrier to keep the paste in the dispensing area. A shutter is actuated to shut off the volume in between dispensing of the paste.

### RELATED APPLICATION/S

This application claims the benefit of priority of U.S. Provisional Patent Application No. 63/466,727, filed on May 16, 2023, the contents of which are incorporated herein by reference in their entirety.

### FIELD AND BACKGROUND OF THE INVENTION

The present invention, in some embodiments thereof, relates to a paste deposition system and, more particularly, but not exclusively, to a deposition system for filling molds with paste to form layers in an additive manufacture procedure.

An additive manufacturing procedure is disclosed in applicant's prior International Patent Application published as WO 2018/203331 on 8 Nov. 2018. In that disclosure it is taught that layerwise production of a part may proceed by using 3D printing techniques such as inkjet printing and suitable materials to print a mold defining an outline of the layer. The space defined by the mold is then filled with a paste. Advantages of the method are its suitability for irregularly shaped parts and the ability to use any material that can be made into a paste. Thus, metal or ceramic parts may be made by mixing metal powder into a paste and subsequently sintering.

The present embodiments relate to issues with the deposition of the paste within the mold. Systems exist which are intended to carry out deposition of coatings onto the bodies of products or onto textiles and the like, and these systems are designed to deal with generally continuous deposition. For example, a continuous feed of textile may pass a paste deposition line and be coated with pastes, such as screen printing color pastes for example. In coating products, the system spends most of its time coating, except for short intervals where one product is exchanged for another. In the present embodiments however, not only is the deposition not continuous, but deposition has to be stopped while waiting for the mold for the next layer to be printed. During the time that the system is waiting, the paste has time to dry.

In fact, in most paste deposition systems, such as for textiles, coating takes place at high temperatures and many pastes are deliberately made with solvents that are selected for their suitability for those high temperatures. However, such temperatures cannot be used in the present embodiments due to the low melting temperatures of the molds. Thus, the pastes used in the present embodiments are modified to dry at lower temperatures, and are thus even more vulnerable to drying during the extended waiting time.

A further issue is that paste deposition is generally carried out using a blade. In fact, a double blade system known as an applicator, is often used, for example U.S. Pat. No. 6,626,097B2, in which two blades surround a volume into which paste is inserted for application. The applicator provides a defined layer of paste with a smooth surface, but has the disadvantage that the blades may damage the mold since the mold is a very soft material.

The coating that forms the layer of the product needs to be of uniform consistency. The paste is formed with uniform consistency, but while waiting in the container for extrusion may become lumpy or may dry out or sediment out, with the result that imperfections may be formed in the part or product being constructed.

### SUMMARY OF THE INVENTION

The present embodiments are designed to address the issues that arise with managing paste during a coating process that is discontinuous.

Paste is continually stirred or circulated and then extruded towards an angled blade applicator which is shuttered in between extrusion operations. The applicator comprises two blades, a front blade and a rear blade, the terms front and rear being relative to the direction of travel of the applicator when applying paste, The rear blade dispenses paste and the front blade acts as a barrier to keep the paste in the dispensing area or volume.

The two applicator blades are angled so that the lower ends face away from the approaching mold wall so that the mold wall may take advantage of springiness in the hold of the blades to push each blade up and back, rather than the edges of the blades being caught on the mold wall. Hence damage to the mold is avoided. Shuttering of the volume between the blades may be automatic based on the position of the applicator or triggered by lifting of the applicator from the surface to which the paste is to be applied. Continuous stirring of the paste in the volume between the blades and the shutter maintains the uniform consistency of the paste, and the paste may thus be applied in a uniform coating without damaging the mold.

According to an aspect of some embodiments of the present invention there is provided a paste applicator for dispensing paste to fill a mold to form a layer in an additive manufacturing process, comprising:
at least one inlet for carrying the paste into an applicator volume, the applicator volume being defined between first and second applicator blades, the first and second applicator blades comprising dispensing ends towards the mold, the first and second applicator blades being tilted such that the respective dispensing ends lean away from a direction of travel during paste dispensing of the paste dispenser; and
a shutter actuatable to shut off the applicator volume in between dispensing of the paste.

In embodiments, each of the applicator blades is tilted away at angles, the angles being more than ten degrees and less than ninety (90) degrees from a perpendicular out of the layer.

The paste dispenser may have a level detector to detect a current level of paste within the applicator.

In embodiments, the paste is water based and the detector is an electric conductance sensor.

In embodiments, the applicator blades are elongated in a direction of elongation, the direction of elongation being parallel to a plane of the layer and perpendicular to the direction of travel during paste dispensing.

The paste dispenser may have a rotational stirrer extending through the applicator volume.

The paste dispenser may have a screw with a thread.

In embodiments, the stirrer comprises a first half length and a second half length and wherein the thread has a first sense along the first half length and a second, opposing sense along the second half length.

The stirrer may be a rod and may be wound with a winding.

In embodiments, the stirrer comprises a first half length and a second half length and the winding has a first sense along the first half length and a second, opposing sense along the second half length.

The paste dispenser may have a rod with at least one mixing element, the nut being movable through the volume to mix the paste.

In embodiments, the rod comprises a thread, and the mixing element is a nut, the nut traversing along the thread.

In embodiments, the rod comprises a self-reversing screw, the nut thereby reciprocating along the thread

In embodiments, the rod is configured to reciprocate linearly within the volume, the at least one mixing element being fixed to the rod.

The paste dispenser may include a vibration source connected to one of the first and second blades to apply vibrations to the one of the blades.

In embodiments, the vibration source is configured to apply the vibrations at a frequency of between 2 and 200 Hz.

According to a second aspect of the present embodiments there is provided a paste applicator for dispensing paste to fill a mold to form a layer in an additive manufacturing process, comprising:
an inlet and first and second applicator blades, the inlet configured to carry the paste into an applicator volume, the applicator volume being defined between the first and second applicator blades, the first and second applicator blades being tilted away from a direction of paste dispensing travel during of the paste applicator.

In embodiments, the applicator blades are tilted away at angles respectively being more than ten degrees and less than ninety degrees from a perpendicular out of the layer.

Embodiments may include a shutter, the shutter located at the dispensing end of the applicator to close off the gap, or to partially or fully open the gap.

According to a third aspect of the present invention there is provided a paste applicator for dispensing paste to fill a mold to form a layer in an additive manufacturing process, comprising:
an inlet and first and second applicator blades, the least one inlet configured to carry the paste into an applicator volume, the applicator volume being defined between the first and second applicator blades; and
a stirrer located within the applicator volume, for stirring the paste, the stirrer having a length and a thread or a winding around the length, the stirrer comprising a first half length and a second half length and the thread or the winding having a first sense along the first half length and a second, opposing sense along the second half length.

According to a fourth aspect of the present invention there is provided a paste applicator for dispensing paste to fill a mold to form a layer in an additive manufacturing process, comprising:
an inlet and first and second applicator blades, the least one inlet configured to carry the paste into an applicator volume, the applicator volume being defined between the first and second applicator blades; and
a vibration source connected to one of the first and second applicator blades to apply vibrations to the one of the blades.

According to a fifth aspect of the present invention there is provided a paste applicator for dispensing paste to fill a mold to form a layer in an additive manufacturing process, comprising:
an inlet and first and second applicator blades, the least one inlet configured to carry the paste into an applicator volume, the applicator volume being defined between the first and second applicator blades, ; and
a shutter actuatable to close off the applicator volume at a dispensing end of the applicator volume when not dispensing the paste.

According to a sixth aspect of the present invention there is provided a paste dispensing method for dispensing paste to fill a mold to form a layer in an additive manufacturing process, comprising:
holding a paste in a dispensing volume between two angled blades;
dispensing the paste in discrete layers from the dispensing volume to fill the mold;
stopping the dispensing in between each layer; and
sealing the dispensing volume during the stopping.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A, 1B and 2 are three side cutaway views of embodiments of a paste applicator according to embodiments of the present invention;

FIGS. 3A and 3B are sections of the blade parts of the embodiments of FIGS. 1A-2;

FIGS. 4A and 4B show a stirrer mounted in a housing according to embodiments of the present invention;

FIGS. 5, 6A-B, 7 and 8 show different embodiments of stirrers and mixers that may be used in embodiments of the present invention;

FIG. 9 is a longitudinal cross-section of a paste applicator according to embodiments of the present invention;

FIG. 10 is a cutaway perspective view of a paste applicator and gears for operating a stirrer, according to embodiments of the present invention;

FIGS. 11, 12 and 13 illustrate an embodiment of a paste applicator according to the present invention in which vibrations are used to keep the paste fresh;

FIGS. 14 and 15 are two illustrations of an embodiment of a round-shaped paste applicator according to embodiments of the present invention; and

FIG. 16 is a simplified flow chart illustrating operation of a paste applicator according to embodiments of the present invention.

### DESCRIPTION OF SPECIFIC EMBODIMENTS OF THE INVENTION

The present invention, in some embodiments thereof, relates to a paste deposition system and, more particularly, but not exclusively, to a deposition system for filling molds with paste to form layers in an additive manufacturing procedure.

A paste dispenser for dispensing paste to discontinuously fill a mold to form a layer in an additive manufacturing process, comprises an applicator to dispense the paste into the mold one layer at a time. The applicator comprises two generally angled blades and a volume in between which holds the paste to be applied. The blades may be tilted so that the ends towards the mold face away from a paste dispensing direction of travel. A shutter is actuated to shut off the volume between the blades in between dispensing of the paste. Such actuation may be implemented by a pneumatic cylinder, a motorized actuator or any number of other known methods.

Double blade applicator units are well known as means to coat or transfer materials, and usually the coated substrate is an endless media, for example in the case of a flexography roller, so that the media is continuously in contact with the blades system and the paste that remains between the blades is not exposed to air. In screen printing of solder pastes, it is also common to have a double blade system. In such a double blade system, the rear blade dispenses paste and the front blade acts as a barrier to keep the paste in the dispensing area.

In the present embodiments however, the double blade system moves in and out of the pallets as each successive layer is filled. In other words, the media is not endless and the operation is discontinuous, with time intervals. For example between changing of a pallet, or during the sequential process as the mold for the next layer is printed. Since the applicator is not in contact with any surface there is no sealing substrate on the lower side of the applicator, and the paste may just flow out from the opening.

The present embodiments accordingly provide a lower shutter that is controllably closed whenever the dispenser reaches the pallet end and ceases to dispense. The shutter may be actuated according to the position of the dispenser. According to one embodiment, the shutter may controllably be held open to leave a required gap. The controllably partially opened gap may be used to regulate the amount of paste being deposited, or to reduce the amount of air getting into the volume. Thus the shutter may have one or more semi-opened states and not just be opened and closed.

When coating other media such as textiles, the media is cured at high temperature. However, in the present embodiments, the mold is made of materials suitable for inkjet printing, and such materials may have a tendency to soften at relatively lower temperatures. Thus such high temperature operations may not be possible.

Hence, the paste in the present embodiments is formulated to dry at low temperature, meaning that it has a tendency to deteriorate, dry or otherwise change consistency at room temp, including while enclosed within the dispenser system.

Accordingly, internal paste mixing, or stirring may be provided, for example, in the volume between the blades and the shutter, hereinafter referred to as the applicator volume. Another way to keep the paste fresh is to circulate the paste in and out of the volume by using a pump.

Embodiments may measure the paste volume and apply more paste as the volume decreases below a specific threshold. For example-when the paste is a water based medium and as such a good electric conductor, at least one electrode may be located in the paste volume. Another electrode is connected to the metal applicator body. An electric current flows between the electrodes as long as the threshold level is maintained, but as soon as the threshold is lost the current fails and the applicator may be filled. To improve the reliability more electrodes may be inserted in the applicator volume. Another option is to measure relative conductivity between immersed electrodes that are at different levels.

The mold material is typically soft since it is selected for inkjet printing, for example paraffin wax may be used, and accordingly, blades may easily damage the mold. As the current layer provides the base for the next layer, damage to the mold may lead to loss of integrity of the part being manufactured, and hence the applicator system of the present embodiments is designed so that the blades come into contact with the mold at angles that are lower than 90 deg relative to the plane of the layer in the direction of travel. The blades accordingly may simply bend backwards slightly when coming into contact with the mold wall and do not damage the mold. The blades may have different angles but are lower than 90 deg.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

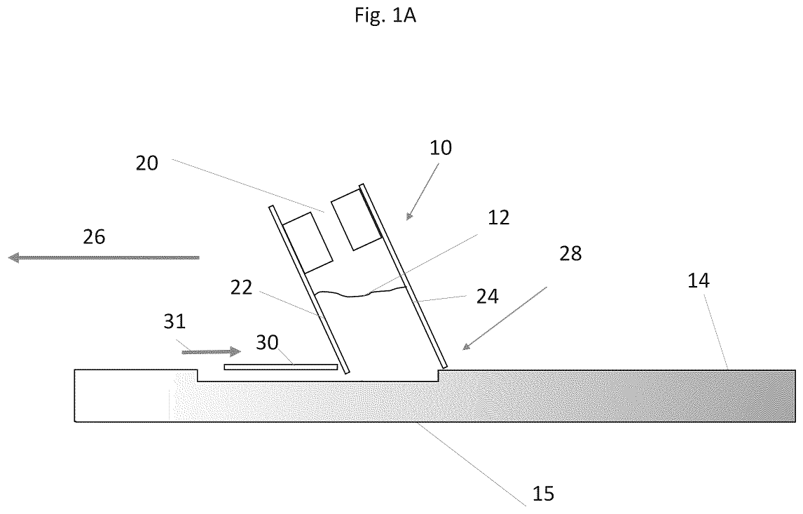

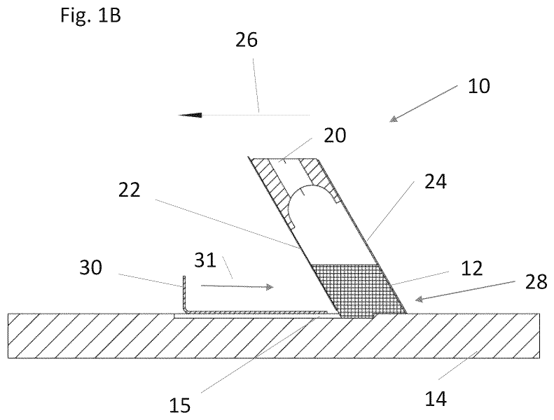

Referring now to the drawings, FIG. 1A is a schematic side cutaway view that illustrates a paste applicator 10 for dispensing paste 12 to fill a cavity 15 in mold 14 to form a layer in an additive manufacturing process.

The applicator 10 includes an inlet 20 for passing the paste 12 into an applicator volume. The applicator volume is the space defined between two applicator blades 22 and 24. The two blades 22 and 24 have paste dispensing ends-see arrow 28, towards mold 14 and are tilted away from a direction of travel 26 so that the dispensing ends lean away from the direction of travel during paste dispensing as indicated by direction of travel arrow 26. A shutter 30 can be actuated to move in the direction of arrow 31 and shut off the applicator volume in between dispensing of the paste.

Referring now to FIG. 1B, the applicator of FIG. 1A is now considered in greater detail. Inlet 20 carries paste from a paste supply system (not shown) to the volume between front 22 and rear 24 blades of an applicator arrangement. During dispensing of the paste, the applicator travels in the direction of arrow 26. Lower ends of each of blades 22 and 24 are inclined at an angle away from the direction of travel, meaning both blades lean backwards in respect of the direction of travel. As a result, when touching the surface of mold 14 the two blades, which are slightly springy, are pushed back by the mold wall, rather than digging into or scratching the mold wall.

In the additive manufacturing process of the present embodiments, the paste, which may be a metal or ceramic paste or a paste of any other suitable material, is in a viscous liquid form, and yet is required to fill the cavities in printed mold 14 efficiently and uniformly, and the applicator may provide such uniformity of application of the paste.

Blades 22, 24, are mounted in the applicator to apply the paste and shutter 30 is provided to shut off the entire gap in between the two blades when not dispensing, so that the paste does not flow out of the paste from the applicator. During dispensing, the shutter may be fully open or may be partially closed. As mentioned, the applicator consists of two applicator blades and a volume therebetween, and the shutter 30 may accordingly be located at the mold contacting or dispensing end 28 of the applicator to close off the volume. Arrow 31 indicates the direction of travel of the open shutter to close the gap.

The blades may be tilted away at an angle being more than five degrees or more than ten degrees and less than ninety 90 degrees from the perpendicular extending out of the layer. It is noted that the blades are not necessarily parallel but each of them may be at a different angle.

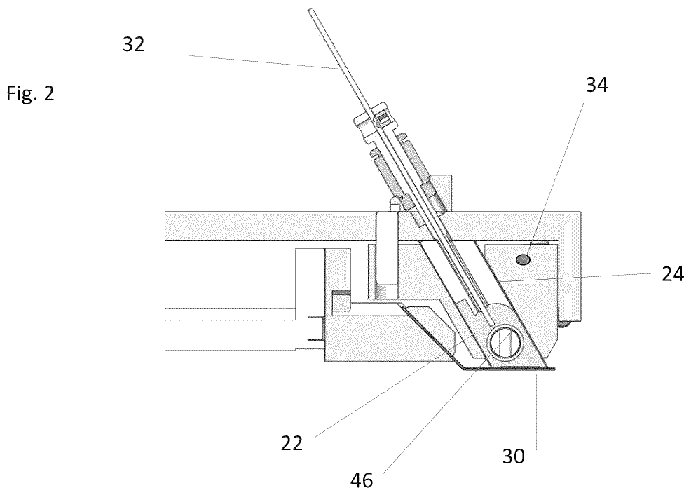

In embodiments, the paste volume is measured, so as to be able to apply more paste as the volume decreases past a specific threshold, paste not being an easy medium to control. A level detector consisting of electrodes 32, 34 (see FIG. 2) may be used. The level detector has a connection 34 to the applicator body. Electrode 32 is immersed in the applicator volume.

In one embodiment, the paste is a water based medium and as such it is a good electrical conductor. Accordingly, the level detection, may consist of an electrode 32 located in the paste volume, at the threshold level, and electrical conductivity is measured in reference to point 34 on the applicator body, to provide a water level sensor. Once the paste falls below the electrode level, the electric current between the two electrodes disappears, hence providing detection of the paste falling below the threshold. Accordingly, the container may be refilled automatically and kept full throughout the process.

Reference is now made to FIG. 2, which is a cross-sectional view showing in greater detail an electrode 32 inserted into the dispensing part of the applicator 10 of FIG. 1A. Detector 34, as referred to above, provides a current to electrode 32 in the presence of paste, and thus a provides a level detector. A Paste flows from a supply system (not shown) through inlet 20 into the gap between front 22 and rear 24 blades of the applicator system. Shutter 30 closes the volume as the dispenser moves away from the part and ceases to dispense paste. A rotatable stirrer 46, or other mixing means, discussed in greater detail hereinbelow, may extend along the applicator volume.

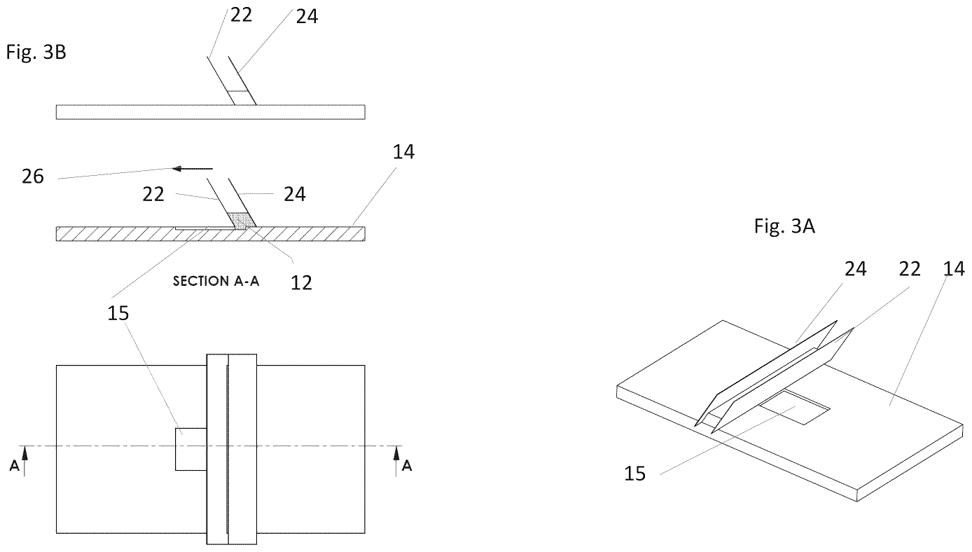

Reference is now made to FIGS. 3A and 3B, which schematically show the concept of the dispensing applicator 10 from a perspective view. The applicator consists of front 22 and back 24 blades as before and is used to fill paste inside cavity 15 in mold 14. The direction of travel is shown by arrow 26. The blades are elongated along an axis which is both parallel to a plane of the layer to be filled and perpendicular to the direction of travel during paste dispensing. As shown, paste 12 in the volume between the blades, is spread into space (cavity) 15 inside the mold and on top of layers already formed. The front blade 22 keeps the paste in the gap and the rear blade 24 ensures that the paste is spread evenly and uniformly in cavity 15 to leave behind a smooth surface. The blades extend upwardly from the paste application surface at an acute angle to the direction of travel of the applicator while applying the paste. The two blades may be at the same angle or may be at different angles respectively, as mentioned hereinabove.

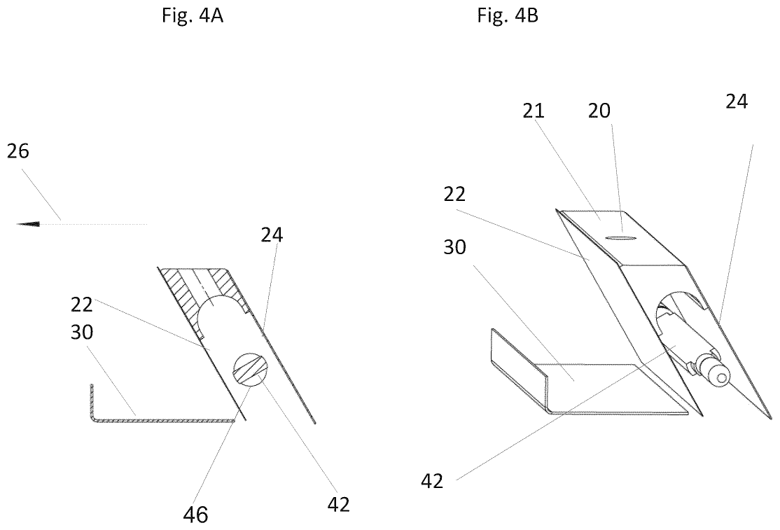

Reference is now made to FIGS. 4A and 4B, which are a cut view and side perspective view respectively illustrating how a stirrer may be mounted in the applicator volume to stir the paste, according to embodiments of the present invention. Upper wall 21 of the applicator volume includes inlet 20 for paste supply. Applicator blades 22 and 24 form front and back walls of the applicator volume, and stirrer 46 is mounted across the volume in parallel with the layer to be applied and perpendicular to the direction of travel. The two ends of the stirrer 46 are rotatably mounted in the ends of the applicator.

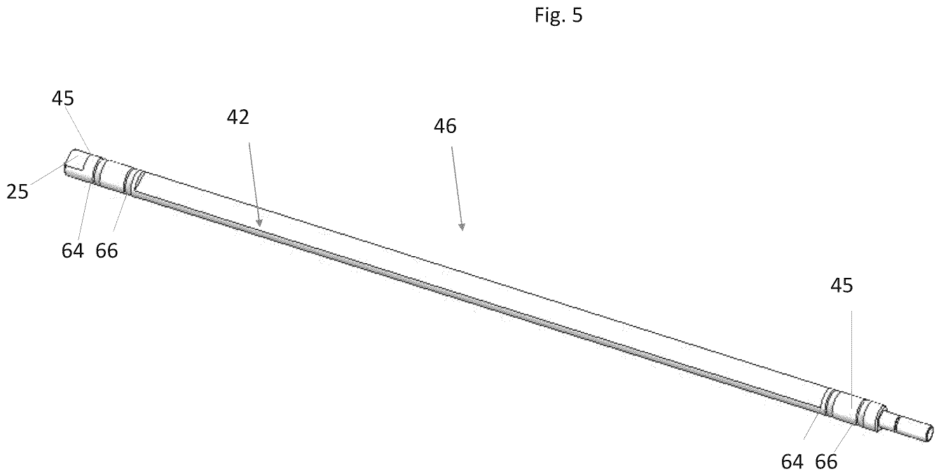

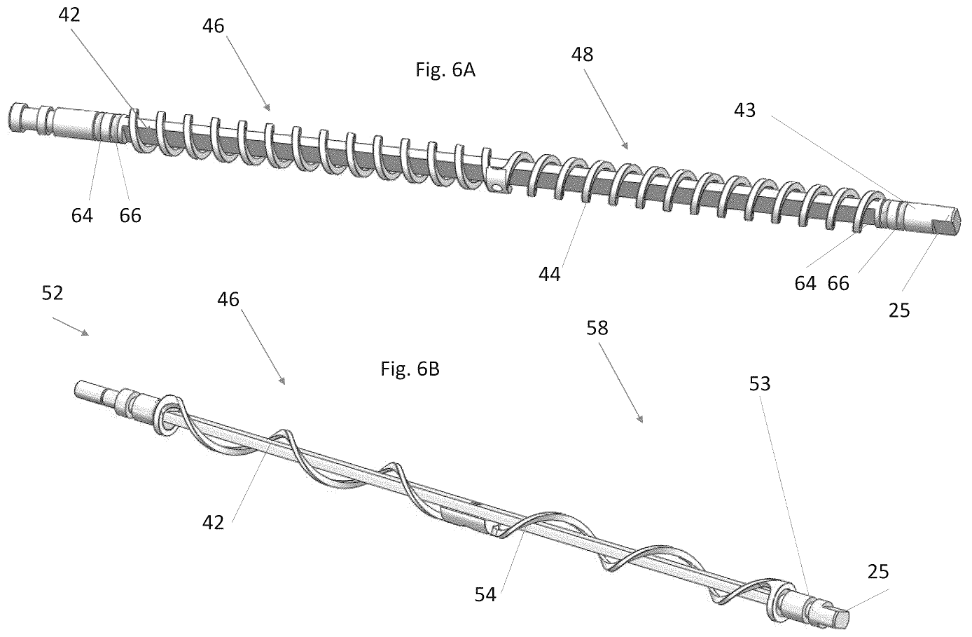

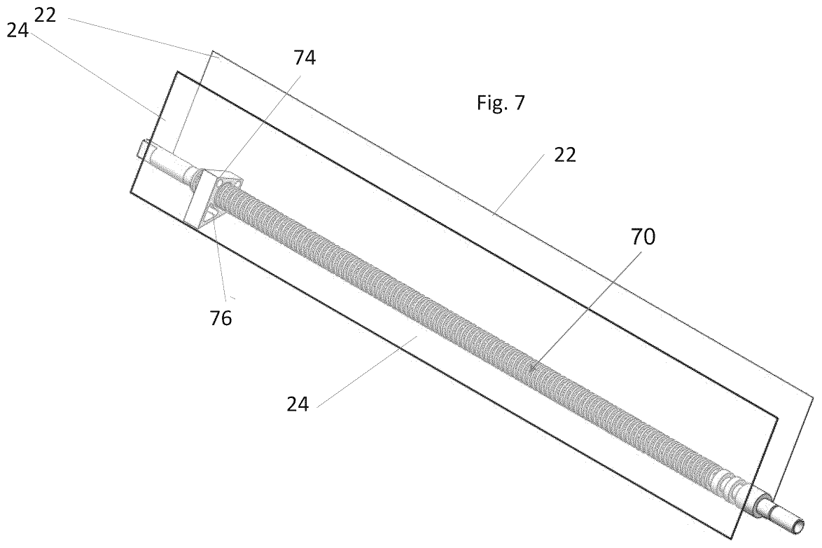

Reference is now made to FIG. 5, which shows in greater detail the stirrer 46 of FIGS. 4A and 4B. The stirrer 46 is a rod with flattened front and rear surfaces 42, which surfaces serve to stir the paste as the rod is rotated.

The stirrer is mounted to the end walls of the applicator volume at extremities 45 and the mounting may be sealed using O rings 64 and 66. One of the ends of the stirrer may include a keyed edge 25 for engagement with a gear motor to transmit drive to the stirrer

Reference is now made to FIG. 6A, which illustrates a variation to the stirrer of FIG. 5 for applicator 10. Stirrer 46 is wound with a coil 44 to improve the stirring of the paste. Instead of a rod with a coil, a screw with a thread may be used. The thread or winding changes direction or sense at the middle of the rod. Thus, first half-length 46 of the rod is wound or threaded in a first sense, and a second half-length 48 of the rod is wound or threaded in a second sense. The result is that if the rod is rotated in one direction, the paste in contact with the rod is forced towards the center, causing paste away from the rod to head away from the center and thus may thoroughly mix the paste. If the rod is rotated in the opposite direction then the paste around the stirrer is forced to the sides and the paste away from the stirrer is forced towards the center. Again, the paste may be thoroughly mixed. In either case, a forced circulation system may be provided for the paste. One of the ends of the stirrer may include a keyed end 25 for engagement with a motor to drive the stirrer. The two ends of the stirrer 46 are rotatably mounted in the ends of the applicator and the mounting may be sealed using O rings 64 and 66.

Reference is now made to FIG. 6B, which is a simplified diagram of another variation of the stirrer of FIG. 5. Stirrer 46 wound with a coil 54. Instead of a rod with a coil a screw with a thread could be used. The thread or winding changes direction or sense at the middle of the rod. Thus, a first half length 56 of the rod is wound or threaded in a first sense, and a second half-length 58 of the rod is wound or threaded in a second sense. The result is that if the rod is rotated in one direction, the paste in contact with the rod is forced towards the center, causing paste away from the rod to head away from the center and thus may thoroughly mix the paste. If the rod is rotated in the opposite direction then the paste around the stirrer is forced to the sides and the paste away from the stirrer is forced towards the center. Again the paste may be thoroughly mixed. The two ends of the stirrer 46 are rotatably mounted in the ends of the applicator and the mounting may be sealed using O rings 64 and 66.

Reference is now made to FIG. 7, which is a simplified diagram illustrating an alternative embodiment in which a linearly traveling nut carries out the task of mixing the paste. Rod 70 is a leadscrew, and as the leadscrew rotates, nut 74, which may be shaped to fit the volume of the space between the applicator blades 22 and 24, moves back and forth along the applicator to mix the paste. Nut 74 may comprise passages 76 to allow paste to flow from side to side. One of the ends of the stirrer may connect with a motor to drive the leadscrew 70. As nut 76 reaches either end, the rod reverses so that the nut 76 travels in the opposite direction.

Leadscrew 70 may also be a self reversing screw, as is known in the industry so that the nut's travel may reverse at either end while rotating leadscrew 70 in the same rotational direction continuously.

Reference is now made to FIG. 8, which illustrates an alternative method for mixing the paste. In applicator 10, one or more nuts 74 with passages 76 are mounted firmly on rod 46 which travels linearly to the right and left in accordance with arrow 75. Rod 46 may be activated by a linear pneumatic piston, a linear motor or any other method well known in the industry.

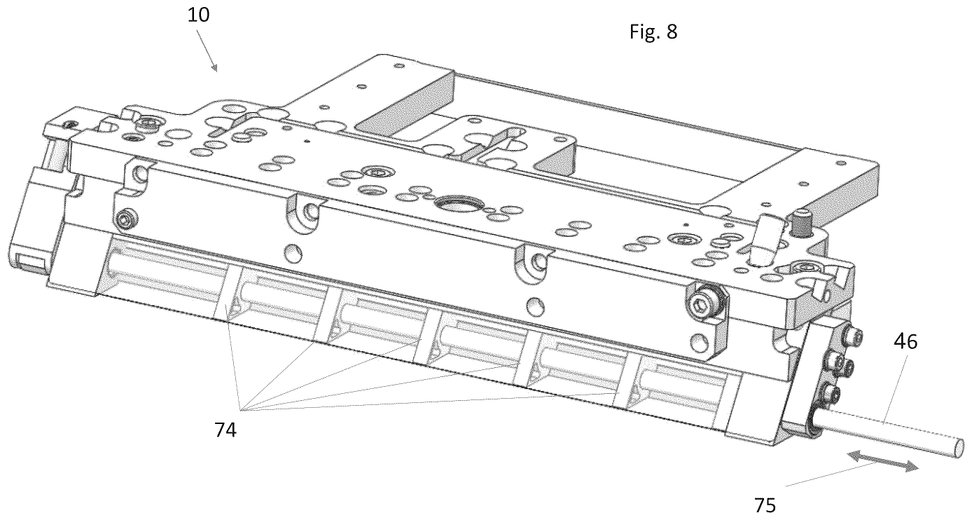

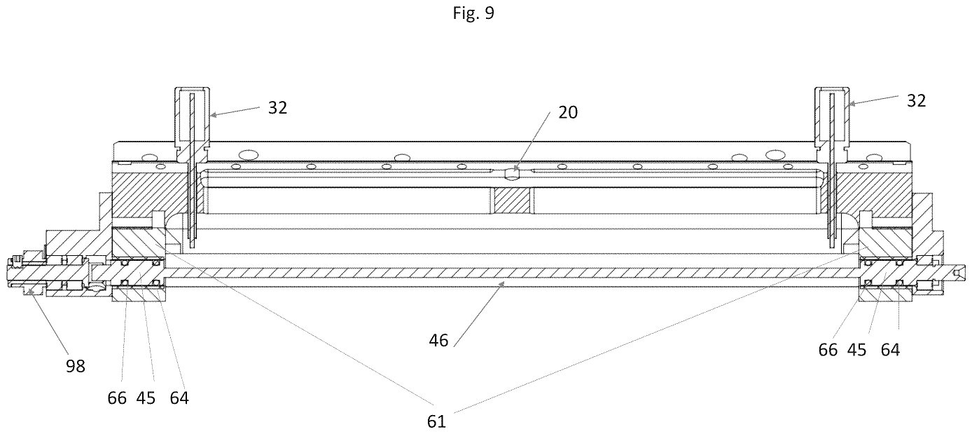

Reference is now made to FIG. 9, which is a simplified diagram showing a longitudinal cross-section of the applicator of the dispenser 10 according to embodiments of the present invention. Paste flows through inlet 20 into the applicator 10, where it is stirred by stirrer 46 and applied downwardly. Level detectors 32 detect the level of the paste in the applicator as above so that further paste may be added as needed. The stirrer is rotatably mounted in the applicator by its extremities 45 and includes O ring seals 64 and 66, to prevent leakage through the rotatable mounting. Gear 98 may engage the stirrer for rotation. Also shown are side seals 61 that seal the applicator sides. Seals 61 may for example be rubber seals.

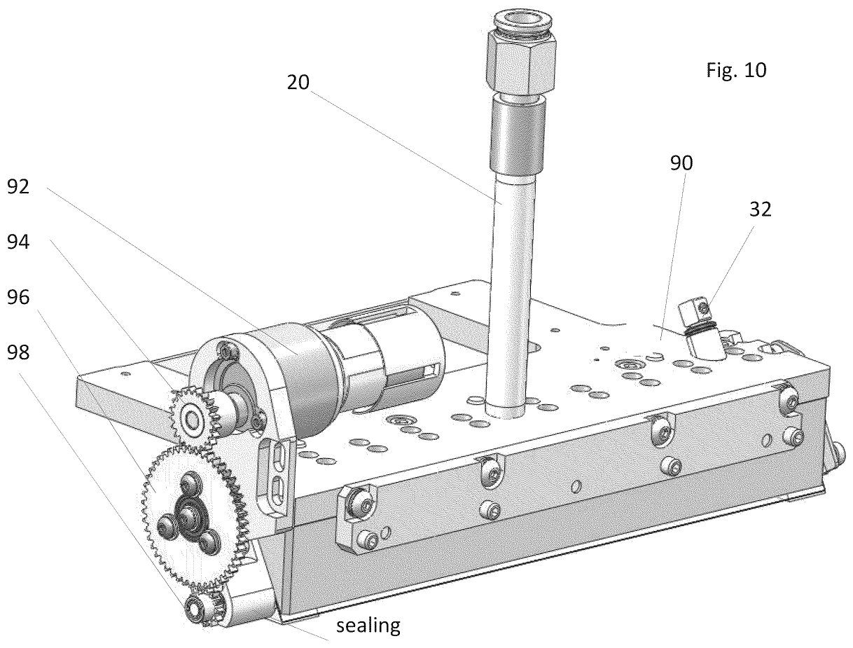

Reference is now made to FIG. 10, which illustrates a way in which the dispenser of the present embodiments may be motorized. A view is shown of the dispensing end of the applicator. Motor 92 operates a sequence of gears 94, 96 and 98, and the lower gear 98 of the sequence of the gears may operate the stirrer.

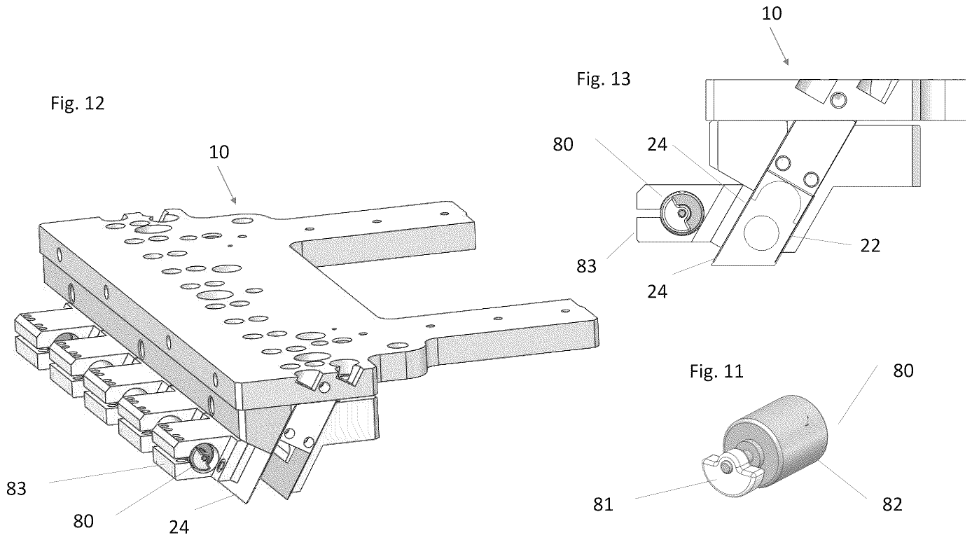

Reference is now made to FIGS. 11, 12 and 13, which illustrate a further embodiment of the paste applicator which uses mechanical vibrations of the paste applying blade 24 in order to keep the paste fresh in between applications. FIG. 11 is a simplified diagram that illustrates a simple vibrator 80, consists of motor 82 and a rotary unbalanced inertial rotating key 81. FIG. 12 is an isometric view of applicator 10. Vibrator 80 is clamped to holder 83 which is in contact with blade 24, which is the paste dispensing blade, as opposed to blade 22 which is the lead blade. FIG. 13 is a side view of applicator 10 with the inertial rotating key mechanism. As motor 81 revolves, the unbalanced inertial key 81 transfers vibrational motion to blade 24, causing blade 34 to vibrate. The vibrations eliminate sedimentation and keep the paste fresh. Vibrations may be applied in more ways known in the industry, and the frequency of the vibrations may typically range between a few Hz and 200 Hz. The use of vibrations during the application of paste is discussed in connection with solder paste in the paper The Behavior of Solder Pastes in Stencil Printing with Vibrating Squeegee-Da He et al. IEEE Transactions on Components, Packaging and Manufacturing Technology—Part C Vol 21, No. 4 Oct. 1998, the contents of which are hereby incorporated by reference.

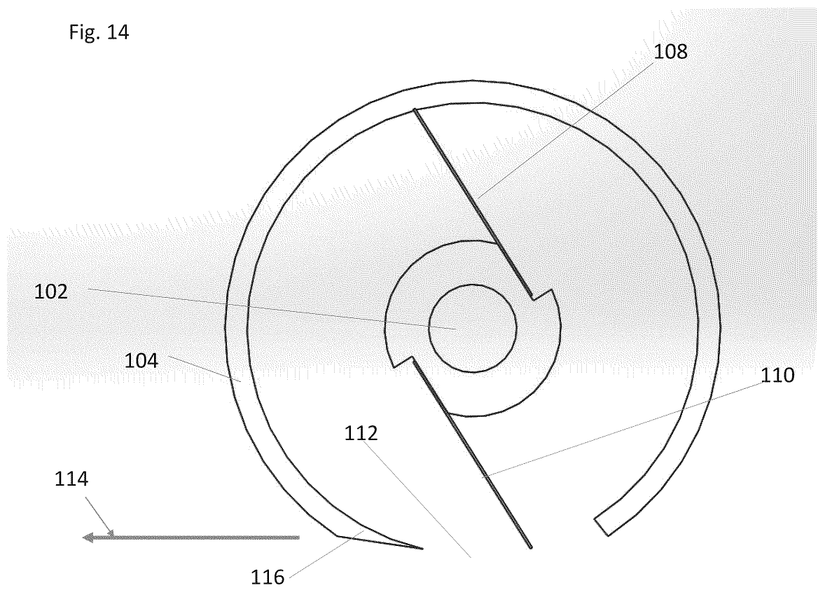

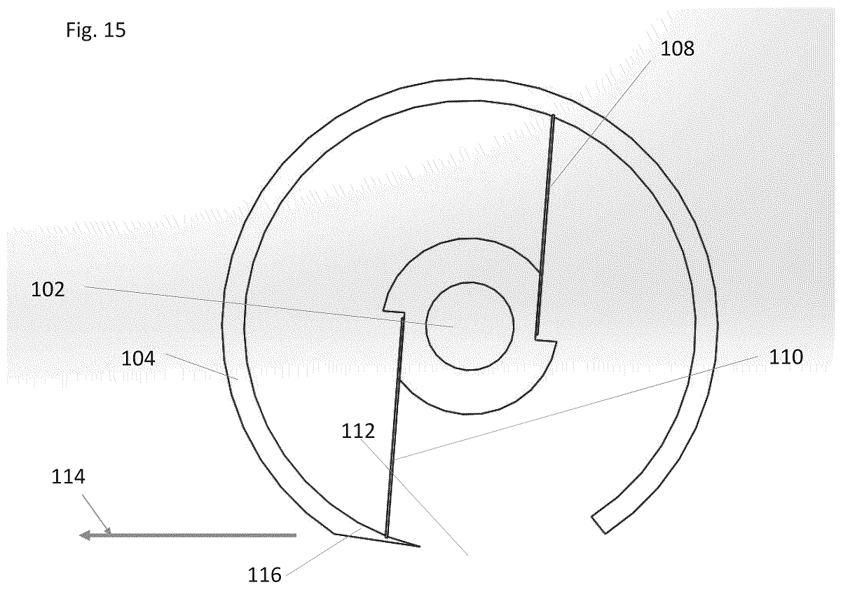

Reference is now made to FIGS. 14 and 15, which are two views of a rotatable dispensing head 100 according to embodiments of the present invention. The paste to be exuded is received from intake 102 and held within outer ring 104. The dispensing head and rotating blades 108 and 110 rotate in a clockwise direction to push paste out through the gap 112 in the outer ring blades 104 and 106. The dispensing head moves in the direction of arrow 114 to dispense paste. Rotating blades 108 and 110 move between an open position in FIG. 14 and a closed position in FIG. 15. Leading edge 116 of outer ring 104 is smoothed and curves against the direction of travel, again to avoid damage to the mold wall.

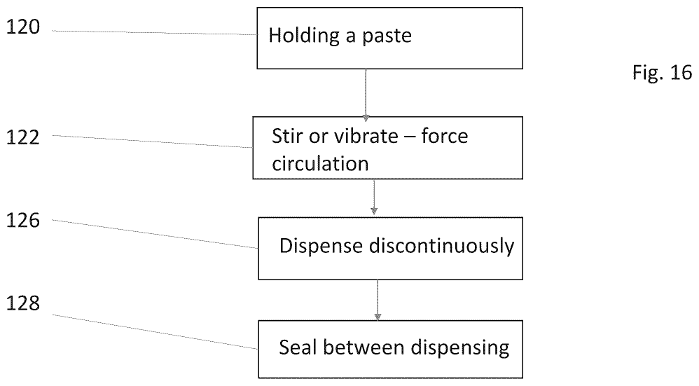

Reference is now made to FIG. 16, which is a flow chart showing operation of an embodiment of the present invention.

The method dispenses paste to fill a mold to form a layer in an additive manufacturing process as discussed above. In box 120 paste is held in the applicator. In box 122, optionally, the paste is stirred or vibrated. As explained above, stirring may include enforcing circulation, or mixing for example by providing mixers with opposite threading or winding over the length of the stirrer, or by using a nut that travels along the thread of the mixer. The nut may include openings through which the paste is forced to pass. Vibration may include vibration of the dispensing blade at say between 2 and 200 Hz.

As discussed, dispensing is discontinuous. That is to say, one layer is dispensed and then the applicator stops, waits for the next layer of mold to be printed and then goes back to the start position to dispense the next layer. The paste may be dispensed—126—from the opening between two angled blades to fill the mold. In between filling each layer the opening may be closed—128—seal off the paste and prevent drying.

It is expected that during the life of a patent maturing from this application many relevant paste compositions and paste dispensation systems will be developed and the scopes of corresponding and other terms are intended to include all new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable sub combination or may be suitable as a modification for any other described embodiment of the invention and the present description is to be construed as if such separate embodiments, sub combinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A paste applicator for dispensing paste to fill a mold space between mold walls to form a plurality of layers in an additive manufacturing process, the additive manufacturing process having a dispensing discontinuity between dispensing of each layer, the paste applicator comprising:
at least one inlet for carrying said paste into an applicator volume, the applicator volume being defined between first and second applicator blades, the first and second applicator blades comprising dispensing ends towards said mold space, said first and second applicator blades being tilted at a tilt angle such that said respective dispensing ends lean away from a direction of travel towards said mold walls during paste dispensing of said paste dispenser, said tilt angle being selected to avoid damage to said mold walls by said dispensing ends; and
a shutter actuatable during said discontinuities to shut off said applicator volume in between dispensing of respective layers of the paste.

2. The paste dispenser of claim 1, wherein each of said applicator blades is tilted away at angles, said angles being more than ten degrees and less than ninety (90) degrees from a perpendicular out of said layer.

3. The paste dispenser of claim 1, comprises a level detector to detect a current level of paste within said applicator.

4. (canceled)

5. The paste dispenser of claim 1, wherein said applicator blades are elongated in a direction of elongation, said direction of elongation being at said tilt angle to said direction of travel during paste dispensing.

6. The paste dispenser of claim 1, further comprising a rotational stirrer extending through said applicator volume.

7. The paste dispenser of claim 6, comprising a screw with a thread.

8. The paste dispenser of claim 7, wherein said stirrer comprises a first half length and a second half length and wherein said thread has a first rotational direction along said first half length and a second, opposing rotational direction along said second half length.

9. The paste dispenser of claim 6, wherein:
said stirrer comprises a rod, the rod being wound with a winding; or
said stirrer comprises a first half length and a second half length and said winding has a first rotational direction along said first half length and a second, opposing rotational direction along said second half length.

10. (canceled)

11. The paste dispenser of claim 1, comprising a rod with at least one mixing element, the mixing element being movable through said volume to mix said paste.

12. The paste dispenser of claim 11, wherein said rod comprises a thread, and said mixing element is a nut, the nut traversing along said thread.

13. The paste dispenser of claim 12, wherein said rod comprises a self-reversing screw, the nut thereby reciprocating along said thread, or wherein said rod is configured to reciprocate linearly within said volume, said at least one mixing element being fixed to said rod.

14. (canceled)

15. The paste dispenser of claim 1, comprising a vibration source connected to one of said first and second blades to apply vibrations to said one of said blades.

16. (canceled)

17. A paste applicator for dispensing paste to fill a mold to form a layer in an additive manufacturing process, comprising:
an inlet and first and second applicator blades, said inlet configured to carry said paste into an applicator volume, the applicator volume being defined between said first and second applicator blades, said first and second applicator blades being tilted away at a predetermined tilt angle from a direction of paste dispensing travel during of said paste applicator, said tilt angle being selected to prevent a lower end of a leading one of said applicator blades from striking a wall of said mold.

18. (canceled)

19. The paste dispenser of claim 17, further comprising a shutter, said shutter located at said dispensing end of said applicator to close off said gap, or to partially or fully open said gap.

20. A paste applicator for dispensing paste to fill a mold to form a layer in an additive manufacturing process, comprising:
an inlet and first and second applicator blades, said least one inlet configured to carry said paste into an applicator volume, the applicator volume being defined between said first and second applicator blades; and
a stirrer located within said applicator volume, for stirring the paste, said stirrer having a length and a thread or a winding around said length, said stirrer comprising a first half length and a second half length and said thread or said winding having a first rotational direction along said first half length and a second, opposing rotational direction along said second half length.

21. A paste applicator for dispensing paste to fill a mold to form a layer in an additive manufacturing process, comprising:
an inlet and first and second applicator blades, said least one inlet configured to carry said paste into an applicator volume, the applicator volume being defined between said first and second applicator blades; and
a vibration source connected to one of said first and second applicator blades to apply vibrations to said one of said blades.

22. A paste applicator for dispensing paste to fill a mold space between mold walls to form layers in an additive manufacturing process, the additive manufacturing process having a dispensing discontinuity between dispensing of each layer, the paste applicator comprising:
an inlet and first and second applicator blades, said least one inlet configured to carry said paste into an applicator volume, the applicator volume being defined between said first and second applicator blades, and
a shutter actuatable to close off said applicator volume at a dispensing end of said applicator volume when not dispensing said paste and configured to be closed during said dispensing discontinuity and opened for each succeeding layer.

23. A paste dispensing method for dispensing paste to fill a mold to form a layer in an additive manufacturing process, comprising:
holding a paste in a dispensing volume between two angled blades;
dispensing said paste in discrete layers from said dispensing volume to fill said mold;
stopping said dispensing in between each layer; and
sealing said dispensing volume during said stopping.

24. The method of claim 23, comprising stirring said paste while held in said dispensing volume, or applying vibrations from a vibration source to one of said first and second blades to apply vibrations to said one of said blades.

25. The method of claim 24, wherein said stirring said paste comprises forcing circulation of said paste around said volume.

26. (canceled)
